(19) United States
(12) Patent Application Publication
(10) Pub. No.: US 2008/0240846 A1
(43) Pub. Date: Oct. 2, 2008

(54) Fence panel mounting system

(76) Inventor: William J.R. E. Phillips, Warren, OH (US)

Correspondence Address: Robert G. Lev;Lev Intellectual Property Consulting, 4766 Michigan Blvd., Youngstown, OH, 44505, US

(21) Appl. No.: 12/079,522

(22) Filed: Mar. 27, 2008

Related U.S. Application Data
(60) Provisional application No. 60/920,415, filed on Mar. 28, 2007.

(51) Int. Cl. F16C 11/00

(52) U.S. Cl. 403/119

(57) ABSTRACT

A mounting system is used to connect panels to upright supports in a barrier system. The barrier has at least one panel and upright supports extending along at least one edge of the panel to support it. The mounting system includes at least two mutually interlocking clamp pieces. These fit together their connection to the same upright support. The clamps also attached to different adjacent panels so that the entirety is held together as one integrated structure.

### PRIORITY INFORMATION

The present invention claims priority to Provisional Patent Application No. 60/920,415 filed on Mar. 28, 2007.

### FIELD OF THE INVENTION

The present invention relates generally to the field of assembling panel-like structures to upright supports. In particular, the present invention is directed to an improvement for connecting fencing panels to upright fence posts.

### BACKGROUND ART

It is standard practice to construct barriers, such as fences, using panels held in place by supports at the lateral edges of the panels. Conventionally, such supports are generally known as fence posts, and are typically driven into the ground to provide structural support for adjacent panels of the fence or barrier. A typical fence or barrier system is constituted by multiple upright support structures with multiple panels, each being supported on two sides by a fence post or upright support. While other fence support arrangements are known in the field of the present invention, conventional upright fence supports are preferred.

A wide variety of different support structures are currently in use, as are a wide variety of different barrier panel arrangements. While materials used for both supports and panels include everything from wood to metal to plastic, the most popular fencing systems are constituted by tubular metal posts and some form of metal mesh panel. One of the most popular and useful variations of metal mesh is constituted by expanded metal mesh panels.

Expanded metal mesh panels (such as the products manufactured by the assignee of the present application, Niles Expanded Metals) are well-known for structural integrity, in a wide variety of different sizes (including thicknesses of metal), and configurations. For example, expanded metal mesh panels have been used as audio speaker grills, decorative interior screens, scaffolding, security fencing, and vehicle barriers. The processes for producing expanded metal mesh panels are well-known, and need no elaboration for purposes of this application.

Of course, the effectiveness of even expanded metal mesh panels as barriers depends a great deal on the upright supports used. Extremely strong upright, tubular metal supports are well-known and easily facilitated under any number of different circumstances. As a result, the stability of conventional upright supports, especially tubular metal supports can usually be taken for granted when designing a barrier or fence system. Strength is often simply a function of the depth to which the upright support is buried.

The desired strength and configuration of a fence or barrier can be provided by an appropriate expanded metal structure and tubular steel supports. Difficulties most commonly occur when connecting the panels and supports together. This is the most vulnerable part of the system. Thus, the connection between upright support and fence panel is critical to maintaining the strength and reliability of the overall system.

Besides the strength of both individual panels, and the overall system, the connection arrangement between supports and fence panels is also crucial for maintaining the esthetics of the fence system. The factor of esthetics is important far more often than is commonly considered for fence systems.

For any kind of fence system, whether emphasizing strength or esthetics, the process of assembly of the fence panels to the upright supports is a major consideration. From this aspect, the connectors are the most crucial component of the fence system. Both the strength and the esthetics of the fence system can be undermined by inappropriate or sloppy assembly. Also, the cost of assembly can be one of the major components of the overall cost of the fence system. Accordingly, a fence system that is difficult to assemble is more expensive, without providing additional advantages.

One reason that tubular, upright supports are so popular is that the adjacent fence panels are easily mounted and aligned with each other. The circular post also means that the adjacent panels can be rotated about the post with respect to each other to accommodate a non-linear stretch of fencing. The tubular posts also accommodate variations in the terrain on which the fence is being mounted.

Most conventional connectors between fence panels and supports are ring arrangements that fit around the tubular structures constituting the upright fence supports. This conventional arrangement allows for a great deal of flexibility in connecting and adjusting the fence panels with respect to the upright supports and each other. Unfortunately, this same flexibility can lead to a compromise in the barrier qualities of the fence system. All too often it has been found very easy to slide fence panels along the upright support so as to affect openings between a fence panel and the ground upon which the fence system is mounted. Correcting this liability and maintaining the reliability of desired characteristics is not necessarily ensured by using additional connectors, an expensive approach.

There are some situations in which the overall strength of the fence or barrier is paramount, such as vehicle barriers. In such arrangements, the strength of the overall system is enhanced if the panels are able to reinforce each other. However, this is difficult to achieve conventionally, even with expanded metal panels. But this is necessary to the absorption of the energy involved in a moving vehicle. Conventional systems do not do this well unless substantial structure is added, increasing expense.

Besides limitations in overall barrier strength, conventional mounting arrangements also permit a substantial amount of skewing or misalignment between fence panels, thereby creating an esthetically unappealing appearance. This is a very common situation with connector rings that are allowed to freely slide along a tubular support.

There are any number of techniques for holding ring connectors in place on tubular supports, thus, maintaining the position of the fence panel with respect to the tubular support. Unfortunately, these conventional techniques are very time consuming, and thus, expensive. Further, in many instances, they entirely defeat the flexibility provided by a ring connector on a tubular support.

Accordingly, there is a need for an improved connecting system to hold fence panels to fence supports or posts. Such an arrangement should facilitate easy installation while maintaining a pleasing appearance. Further the connector arrangement should facilitate the mutual support of adjacent fence panels, strengthening the overall system.

### SUMMARY INVENTION

Accordingly, it is a first object of the present invention to correct various deficiencies of the conventional art.

It is another object of the present invention to provide a fence or barrier system with enhanced strength.

It is a further object of the present invention to provide a fence system which is easy to assemble.

It is additional object of the present invention to provide a fence system that is easily aligned.

It is still another object of the present invention to provide a fence system that has a pleasing appearance.

It is yet a further object of the present invention to provide a barrier system wherein adjacent panels are mutually reinforcing.

It is again an additional object of the present invention to provide a barrier system in which adjacent panels are kept in line with each other, so that the overall fence system is aligned for a pleasing appearance.

It is still another object of the present invention to provide a barrier system that fully utilizes the beneficial characteristics of expanded metal mesh panels.

It is again a further object of the present invention to provide a relatively inflexible barrier that still permits a variation in angles between adjacent panels.

It is yet an additional object of the present invention to provide a barrier system in which tension bands are not required to obtain the benefits of conventional tension bands.

It is still another object of the present invention to provide a barrier system in which couplings between panels and support posts are all identical.

These and other goals and objects of the present invention are achieved by a connecting system for holding panels to at least one upright support extending along at least one edge of the panel. The mounting clamp system includes at least two mutually interlocking clamps, each mating clamp attaching to separate one of two adjacent panels, and to a common upright support.

### DESCRIPTION OF THE DRAWINGS

FIG. 1 is a perspective view of a first preferred embodiment having the interlocking clamps in a separated, pre-installation position.

FIG. 2 is a perspective view of the two clamps of FIG. 1, interlocked with each other for mounting on tubular support.

FIG. 3 is a top view of FIG. 2 when the clamps are interlocked and mounted on a support post P.

FIG. 4 is an isometric view of a second preferred embodiment of the present invention.

FIG. 5 is a front view of two clamps of FIG. 4 in a separated, pre-installation position.

FIG. 6 is an isometric view of the two clamps of FIG. 5.

FIG. 7 is a top view of the assembly of the two clamps, mated with each other, as assembled on a tubular support or post P.

### DETAILED DESCRIPTION OF THE PREFERRED EMBODIMENT

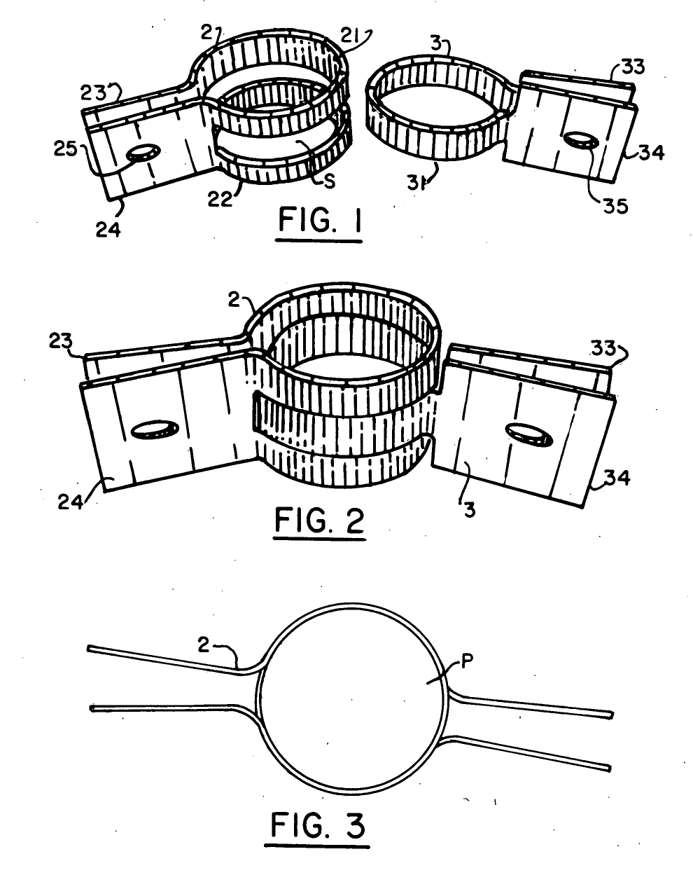

A first preferred embodiment of the present invention is constituted by the panel (not shown) connecting arrangement 1 depicted in FIG. 1. The environment in which this invention is used is constituted by at least two barrier or fence panels, one for each of clamps 2 and 3. The two clamps interlock, as depicted in FIGS. 2 and 3, and slide over a support or post P, as depicted in FIG. 3.

The barrier or fence panels, not shown, are supported by a support or post P using conventional structures. Accordingly, additional description and depiction of these environmental elements for purposes of understanding the present invention are not required.

The panels constituting most of the fence or barrier can be made of virtually any material. The panels can be solid or mesh, in virtually any configuration. In one preferred embodiment, the panels are made of expanded metal mesh, such as the panels manufactured and sold by the assignee of the present invention (Niles Expanded Metals Corp. of Niles, Ohio). Expanded metal can be manufactured in a number of different sizes (metal thickness) and configurations. These will be determined by the ultimate use to which the barrier or fence is to be put.

The clamps 2, 3 are paired as depicted and are connected to their respective panels by means of flanges 23, 24 and 33, 34, respectively. These flange pairs have mounting apertures, 25, 35, respectively so that connectors can hold the clamps 2, 3 to their respective panels. These connectors (not shown) can be of any suitable type for the paneling material, environment, and use in which the fence or barrier is to be put. The number of paired clamps 2, 3 on a particular support is determined by support length, cost and required strength of the barrier system.

Post P as depicted in FIG. 3 is preferably a standard tubular steel fence support. However, depending upon the requirements of the fence or barrier, Post P can be virtually any thickness deemed appropriate by those specifying the requirements the fence or barrier. Post P may even made of a plastic material which is reinforced by structures (not shown) inserted into the interior. Further, the post can also be filled with concrete, and act as no more than a form and later sheathing for the concrete interior. While the post is preferably a tubular material, other shapes can be used within the concept of the present invention. The tubular shape is preferred because of the flexibility and ease of installation afforded by the use of the tube.

FIG. 2 depicts the interlocking of clamps 2, 3 before being installed on the tubular Post P. A first clamp 2 has upper and lower encircling sections 21, 22 with a space in between them. A single encircling section 31 from the second clamp is inserted into space S before the total interlocked structure 1 is slipped over support Post P. It should be noted that support post P generally dictates the size of the circumference of clamps 2, 3. However, the nature of the clamps is such that certain range of adjustability is permitted to accommodate variations in post size.

The preferred use of the expanded mesh panels provides an additional benefit of the present invention. The strengthening of the overall structure by the reinforcing of adjacent panels is facilitated by the mutual support provided by adjacent panels. This is accomplished through the use of complementary, interlocking connecting arrangement 1. Because of the interlocking between the two clamp pieces 2, 3, relatively stiff expanded metal panels (not shown) cannot be easily moved relative to each other. As a result, they reinforce the strength of each other, and thus, the strength of the overall barrier or fence system. This interlocking capability also maintains a pleasing appearance by maintaining alignment between adjacent panels.

It should be clear that many of the advantages of the present invention are obtained by the close interlocking between clamps 2, 3. However, there are also certain disadvantages to a very tight interlocking arrangement such as that depicted in FIGS. 1-3. It should be understood that this interlocking arrangement does not depict the entire range of interlocking, mating, fitting or accommodating arrangements between clamps in accordance with the present invention.

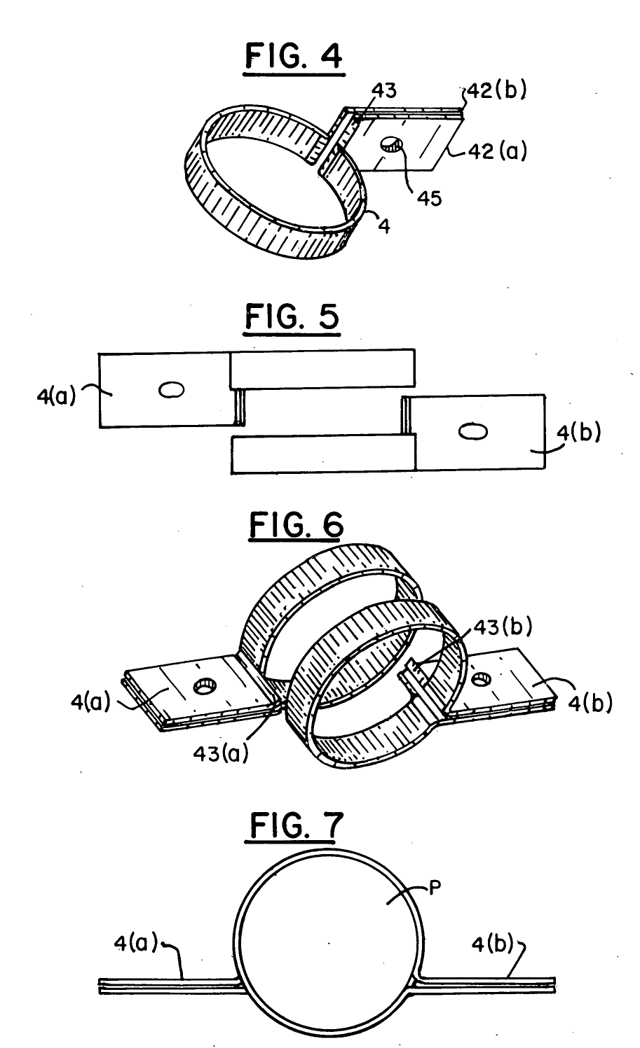

For example, in a second preferred embodiment (as depicted in FIGS. 4-7), a far more flexible and accommodating interlocking can be used. A major advantage of this is that easier installation is facilitated because the two clamps do not have to fit together before being placed on post P.

Clamp 4 (in FIG. 4) has encircling or enclosing section 41 that is preferably configured to match the shape of post P. Like the clamps in FIGS. 1-3, the enclosing section 41 has two ends that are separate and attached flanges 42(a), 42(b). As with the embodiments in FIGS. 1-3, flanges 42(a), 42(b) are meant to fit on either side of the panel to which clamp 4 is connected.

The alignment of flanges 42(a), 42(b) is such as to lie flat against the surface of the panel being connected. Connection between clamp 4 and the panel is facilitated by through hole 45. It should be noted that any arrangement for connecting the flanges 42(a), 42(b) to the external panel falls within the concept of the present invention. A wide range of connecting techniques will occur to those skilled in this particular art, depending upon the exact design of the external panel to be connected. Consequently, these need not be elaborated upon further for purposes of understanding the present invention.

A major advantage of this embodiment is that two different types of interlocking clamps are not needed. Rather, all the clamps 4 can be the same size (depending on post size) and same type, and still achieve useful mating or interlocking with each other. Thus, complexity of manufacturing is reduced, as is the complexity of assembling the clamps 4(a), 4(b) to connect the external post P with the external panels (not shown).

Interlocking is achieved by the simple expedient of doubling the height of flanges 42(a), 42(b) over that of the enclosing section 41. This means that adjacent clamps 4(a), 4(b) can fit next to each other and be in contact with each other to facilitate a close fit, thereby achieving a useful form of interlocking.

The close fit is facilitated by curved lip 43 on each of the clamps 4. This lip is curved to accommodate and fit closely with the curved enclosing section 41 of an adjacent clamp 4. This arrangement permits easy adjustment of the two clamps 4(a), 4(b) with respect to each other while still maintaining a certain level of interlocking when the two are brought together, in the final fitted or interlocked position.

Thus, while the interlocking of the preferred embodiment of FIGS. 4-7 is not as tight as that between the preferred embodiment of FIG. 1-3, a substantial amount of time can be saved in the installation of the fence system since the two clamps do not have to be fit together before being placed on post P. Also, lips 43(a), 43(b) provide a great deal more flexibility for fitting between the clamps 4(a), 4(b) than is possible with the preferred embodiment of FIGS. 1-3. This renders the overall installation process much easier, and thus much cheaper. There is also sufficient interlocking that many of the structural advantages of the preferred embodiment of FIGS. 1-3 are still maintained.

Also, while upright or vertical supports are preferred, horizontal supports can be used for a horizontal barrier orientation for most embodiments of the present invention.

While the present invention has been described by the way of example, the invention is not limited thereto. Rather, the present invention should be construed to included every and all variations, permutations, adaptations, derivations, and embodiments that would occur to one skilled in this art after disclosure of present application. Accordingly, the present invention should be construed as being limited only by the following claims.

1. A connecting system for holding external panels to at least one external upright support extending along at least one edge of at least one of said external panels, said connecting system comprising:
a) two mutually interlocking clamps, each said mating clamp connecting to a common external upright support and to separate, adjacent external panels.

2. The connecting system of claim 1, wherein said clamps are identical.

3. The connecting system of claim 2, wherein each said clamp comprises:
i. an enclosing section with two ends; and
ii. a pair of connecting flanges, each connecting flange extending from one of said ends of said enclosing section.

4. The connecting system of claim 3, wherein said enclosing section has a first predetermined height and said flanges each has a second predetermined height substantially twice that of said enclosing section.

5. The connecting system of claim 4, wherein at least one of said flanges comprises a receiving lip contoured to mate with a portion of an enclosing section of an adjacent one of said clamps.

6. The connecting system of claim 5, wherein said receiving lip is arranged on a portion of said connecting flange not directly extending from said end of said enclosing portion of said clamp.

7. The connecting system of claim 6, wherein each said receiving lip is contoured to match a contour of said enclosing portion of an adjacent one of said clamps.

8. The connecting system of claim 7, wherein mating of adjacent clamps occurs only when said clamps are fitted over a common external post.

9. The connecting system of claim 8, wherein each said connecting flange of each said clamp is parallel to a second said connecting flange of said clamp.

10. The connecting system of claim 3, wherein each said connecting flange comprises means for securing said connecting flange to an external panel.

11. The connecting system of claim 10, wherein said means for connecting said flanges comprise at least one through hole in each said flange.

12. The connecting system of claim 2, wherein said clamps are selected from a group of materials consisting of metal, plastic, and nylon.

13. The connecting system of claim 1, wherein said clamps are arranged in complementary pairs and are non-identical.

14. The connecting system of claim 13, wherein said first clamp of said complementary pair has a first enclosing section, and said second clamp of said complementary pair has two enclosing sections.

15. The connecting system of claim 14, wherein said first enclosing section of said first clamp of said complementary pair of clamps is positioned to fit between said two enclosing sections of said second clamp of said complementary pair.

16. The connecting system of claim 15, wherein each enclosing section of said second pair of clamps has two ends and a connecting flange extending from said ends of said clamps.

17. The connecting system of claim 16, wherein said connecting flanges of each clamp are arranged in parallel pairs, each said connecting flange of each said pair being arranged on opposite sides of an external panel being connected to said clamp.

18. The connecting system of claim 17, wherein each said enclosing section of said second clamp of said complementary pair connects to common connecting flange.
